(19) United States
(12) Patent Application Publication
(10) Pub. No.: US 2005/0271364 A1
(43) Pub. Date: Dec. 8, 2005

(54) Method of foiling copy protection for DVDs

(76) Inventor: Bradley Thomas Collar, Valencia, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/089,785

(22) Filed: Mar. 25, 2005

Related U.S. Application Data
(60) Provisional application No. 60/556,849, filed on Mar. 26, 2004.
(60) Provisional application No. 60/556,914, filed on Mar. 26, 2004.

(51) Int. Cl. H04N 5/76; H04N 5/781

(52) U.S. Cl. 386/94; 386/126

(57) ABSTRACT

A disc burner receives a disc to be copied and checks whether it is an original disc or a recordable disc. If it is an original disc, its contents are copied with a copy protection indication. If it is a recordable disc, a check is performed to determine if it has a copy protection indication and copying is performed only if allowed by said copy protection indication.

### RELATED APPLICATIONS

This application claims priority to Provisional Application Ser. No. 60/556,849 filed Mar. 26, 2004, and incorporated herein by reference.

This application is also related to application Ser. No. ______ filed Mar. 24, 2005 that claims priority to Provisional Application Ser. No. 60/556,914 filed Mar. 26, 2004, and incorporated herein by reference.

### BACKGROUND OF THE INVENTION

1. Field of the Invention

This invention pertains to a method of foiling the prevention of copying of a DVD, the prevention method being described in my co-pending application Ser. No. ______ filed on Mar. 24, 2005 and based on U.S. Provisional application Ser. No. 60/556,849 filed Mar. 26, 2004. (My primary goal is to prevent unauthorized copying. Because I have discovered how my basic method of preventing copying can be foiled, I am seeking patent protection on the foiling method so that injunctive relief can be obtained against a company that attempts to neutralize my copy protection scheme.) Moreover the invention may also be used to make copies of original DVDs that have unprotected content or content in the public domain and therefore are not entitled to copy protection.

2. Description of the Prior Art

An optical disc, such as a CD, DVD, HD-DVD or Blu-ray Disc (collectively “DVD”), has a very large digital data storage capacity. At first, the making of DVDs was a complicated process and DVDs could be made only in special pressing plants. However, devices known as DVD burners have become available that can write data on blank (recordable) DVD discs. Some DVD burner software allows a user to make an unauthorized copy on a recordable DVD of the programming content of an original or prerecorded DVD. Although certain prerecorded DVDs have anti-copying protection, such as CSS, that anti-copying mechanism has been compromised.

At least one company, 321 Studios of St. Charles, Mo., is or was selling software called DVD X-COPY that can be used to make a second generation copy of an original DVD. The software, however, will not make additional copies from the second generation copy. The reasoning (albeit a flawed one) is that one archival copy should be allowed, but not rampant copying. This is obviously unsatisfactory because an unlimited number of second generation copies can be made from the first generation original pressed disc.

### SUMMARY OF THE INVENTION

Briefly, in the above-identified co-pending application I described a copy protection invention that makes a DVD X CPY-type software think that an original first generation disc is a second generation disc that was made by copying. The software therefore will not copy this original or first generation disc. The original DVD adheres to all the relevant DVD specifications and, accordingly, its contents can be reproduced by any standard player. However, any attempt by a user to copy this original or prerecorded DVD on a DVD burner using software such as DVD X-COPY will not be successful.

The DVD X-COPY software writes a file that it calls ‘archive.txt’ on any disc that it makes. Then, the software always looks for that file in a disc that it is called upon to copy, and will make a copy of the disc only if does not contain an archive.txt, or other similar copy protection indication. If the copy protection indication is found, the software is made aware that the disc it is being asked to copy is itself a copy, and should not be copied.

My copy protection invention places the archive.txt file, or any file used for a similar purpose, on an original disc. If a first generation disc is placed in a DVD burner, the software mistakenly thinks that it is a second generation copy and will not copy it.

According to this invention, the above-described copy protection technique is foiled by including in the burning software a routine that checks whether the disc is an original disc or is a recordable disc (e.g., DVD-R) on which a copy has been made. If the disc is an original disc (e.g., a DVD-VIDEO), then software does not look for a copy protection indication, but proceeds to copy the original DVD. Therefore, even if the copy protection indication is present, a copy is made. Only if the disc is recordable and includes a copy protection indication, is making a copy barred.

### DESCRIPTION OF THE DRAWINGS

FIG. 1 shows how data is organized on a prior art first generation DVD;

FIG. 2 shows how a first generation DVD is burned using existing software;

FIG. 3 shows how data is organized on a prior art first generation DVD;

FIG. 4 shows how data is organized on a first generation DVD in accordance with this invention; and

FIG. 5 shows how the flow chart of FIG. 2 can be modified to foil my copy protection method.

### DETAILED DESCRIPTION OF THE PREFERRED EMBODIMENT

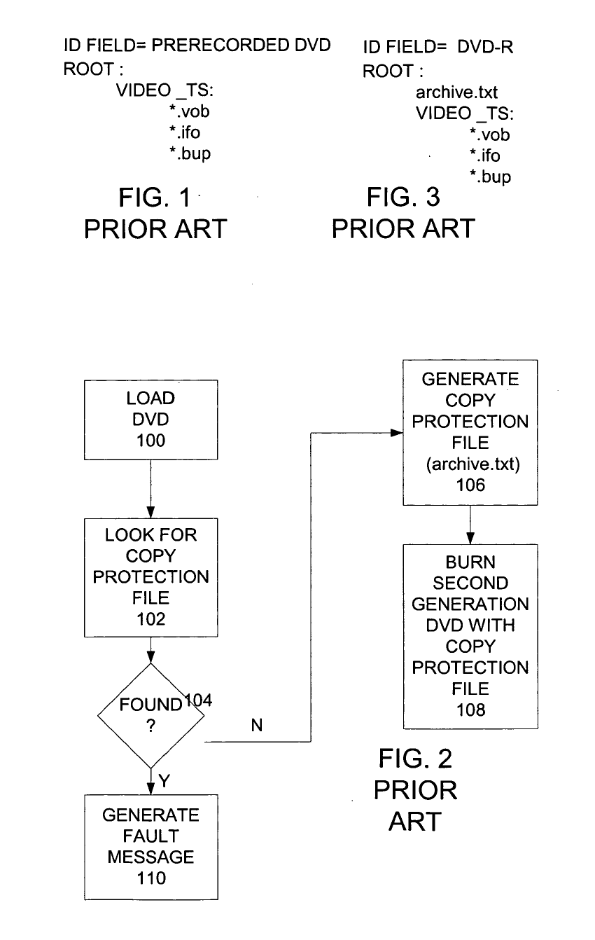

As shown in FIG. 1, typically a prerecorded or pressed DVD, like most other types of data storage media, has data files organized in a hierarchical directory system. More specifically, an original DVD has a ROOT directory with a VIDEO_TS subdirectory. The VIDEO_TS subdirectory includes the normal components of a multimedia presentation, such as video object files identified as *.vob, navigational information files identified as *.ifo, and backup files, identified as *.bup. In the present application, this type of disc is referred to as an original or first generation disc.

As discussed above, the DVD X-COPY software can be used to make second generation DVDs, but not third generation DVDs (where the second generation DVD is made by DVD X-Copy). The operation of a DVD burner controlled by this program is described by the flow chart of FIG. 2. (The flow chart depicts only the steps necessary to understand the invention, and omits the usual steps for playing a DVD disc.) In step 100, the original DVD is loaded into the DVD burner. In step 102, the program looks for a copy protection file. The copy protection file is one that the software itself writes to a recordable disc when making a second generation copy of an original disc (see step 106 below). Therefore, the copy protection file is not found on a standard original disc.

If no file is found in step 104, then the making of a disc copy is permitted. In step 106 a copy protection indication file is generated. The file may include some standard text and information indicating what software was used, the software version, the date on which the file was generated, flags indicating rules governing whether the file can be copied (e.g., “copy never,” “copy once,” “unrestricted copying”) etc. Alternatively, the copy protection file can even contain no information in the case where (as in the case of DVD X-COPY) the software merely looks for the file's presence (in step 104), but not any specific content of the file. In the case of DVD X-COPY, the software calls this file “archive.txt”. In step 108, the contents of the original DVD are copied on a recordable DVD to make the second generation copy. The copy protection file archive.txt is created and recorded on the second generation copy.

FIG. 3 shows the data on the second generation DVD. In the case of DVD X-Copy, the copy protection file (archive.txt) is shown in the ROOT directory. Obviously, this or similar files can be placed anywhere else on the DVD as well so long as the playback of the DVD on a standard player device will not be impaired.

Referring back to FIG. 2, when a second generation DVD is inserted into the DVD burner, in step 104 the copy protection file is found. Then in step 110 the software generates a fault message indicating that copying of this DVD is not permitted, and the software will not copy the DVD.

As discussed above, the overall sequencing does not prevent a user from making multiple second generation DVDs from an original DVD. Moreover, most distributors of content on original DVD-ROM and DVD-Video discs do not want even a single second generation copy to be made. Therefore, according to my invention, an original DVD is made in a way that it is mistakenly recognized by copying software, such as DVD X-COPY, as being a second generation DVD (even though it is really a first generation) and will not make a copy of it.

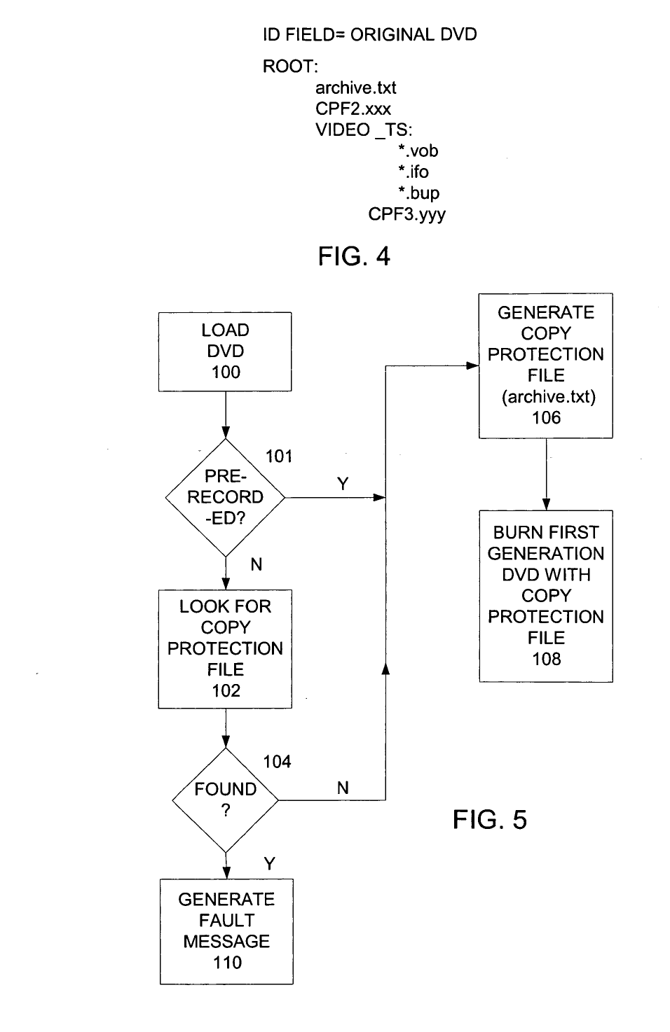

More particularly, as shown in FIG. 4, an original DVD is produced that includes in its ROOT directory (but may also be located in some other location so long as playback is not affected) a copy protection file, such as archive.txt, as well as the other standard files in the VIDEO_TS directory. When this first generation DVD is inserted into the DVD burner, the software finds the copy protection file in step 104 and therefore handles it as a second generation recordable DVD and will not copy it. Typically, the copy protection file (or files if multiple copying programs are to be foiled) is inserted during the disc authoring process and is thereafter incorporated on each original disc through replication.

In the most recent version of DVD X-COPY, the contents of the file archive.txt do not matter. If in future versions, or in different disc copying products, the contents of the file do become material, the copy protection file impressed on the first generation DVD should satisfy whatever the software's requirement is for indicating that the DVD is a copy. Moreover, the copy protection file could have other formats as well. For example, the file could be a binary file. In one embodiment of the invention, this binary file contains only binary zeros.

As discussed above, the program DVD X-COPY looks for the copy protection file archive.txt in the root directory. Other software programs may be provided that may look for a different copy protection file, such as CPF2.xxx in the ROOT directory, or CPF3.yyy in the VIDEO_TS directory. Therefore an original DVD can include these files as well, as shown in FIG. 4. As new software is written to copy DVDs, if it writes on a copy some indication that the disc is a copy of an original and should not be copied, then that software can be foiled from making even a second generation copy simply by including that indication on an original disc. As should be apparent, discs can contain multiple copy protection files on a single disc to foil a wide variety of disc copying software programs which, individually, rely on the presence or absence of different copy protection files in determining whether an archive copy is permitted.

My present invention—how to foil my copy protection invention—is to have the burning software check whether the disc is an original or recordable disc. If it is an original disc, then there should be no archive.txt or similar copy protection indication on the disc. Thus the software simply ignores the file, even if it is on an original disc, and copies the disc. Only if the disc is recordable does the presence of the archive.txt or comparable file prevent copying.

FIG. 5 is a flow chart that shows how a DVD X-COPY-type burning software can be modified so as to foil my copy protection method. The only difference between this flow chart and the one in FIG. 2 is the new step 101. After the DVD is loaded, a check is first performed to determine if it is an original pre-recorded DVD. As discussed above, typically this information is included in the ID-FIELD as shown in FIG. 1. If it is, then the DVD proceeds with the copying process shown in steps 106 and 108. If the loaded DVD is not a pre-recorded disc then in step 102 a search is conducted for a copy protection file as in FIG. 2.

The present invention can be used to allow the copying of original DVDs that are not entitled to copy protection but contain means of preventing copying anyway. For example, original DVDs may include only data and files that have been released in the public domain by their creator or are in the public domain because any copyrights therein have expired.

Obviously, numerous modifications may be made to this invention without departing from the scope of its claims.

1. A method for foiling a copy protection technique, said copy protection technique causing DVD copying software that normally copies first generation discs but not second generation discs not to copy even first generation discs by placing on a copy made by the software an indication that the disc is a copy and said DVD copying software further looking for that indication on any disc that it is called upon to copy and not copying the disc if the indication is present, by placing said indication on first generation pressed discs so that the software mistakenly determines that the disc is a second generation copy, said method comprising having said DVD copying software determine if the disc being copied is a first generation disc and, if it is, copying the disc regardless of the presence of said indication on the disc.

2. A method of determining whether to permit the copying of an optical disc, comprising the steps of:
determining if said optical disc is an original or a recordable disc;
if said optical disc is an original disc then permitting the copying of said original disc to make a second generation disc and adding to said second generation disc a copy protection indication; and
if said optical disc is a recordable disc then determining if said recordable disc includes said copy protection indication,
in the absence of the copy protection indication, copying said optical disc to make a second generation disc, including said copy protection indication; and
in the presence of the copy protection indication refusing to copy the optical disc.

3. The method of claim 2 wherein said copy protection indication is one of a text file and a binary file.

4. The method of claim 3 wherein said copy protection indication is an empty text file.

5. The method of claim 3 wherein said copy protection indication is a binary file of zeros.

6. A method of determining whether to permit the copying of an optical disc, comprising the steps of:
scanning the file system of the optical disc for the presence of a copy protection indication indicating that the optical disc has been copied from an original disc;
ascertaining whether the optical disc is a recordable optical disc or an original optical disc, and
determining to permit copying of the optical disc if said indication is not present or the optical disc is an original optical disc, and determining to prevent the copying of the optical disc if the optical disc is a recordable optical disc and said file is present.

7. A method of controlling the copying of optical discs comprising:
receiving an optical disc;
determining if said optical disc is a recordable or an original disc;
if said optical disc is an original disc, allowing said optical disc to be copied;
if said optical disc is a recordable then checking whether said recordable disc includes a copy protection indication; and
allowing the copying of said recordable disc based on said copy protection indication.

8. The method of claim 7 wherein said copying of said recordable disc is allowed only if said copy protection indication is present.

9. The method of claim 8 further comprising adding to the copied disc said copy protection indication.

10. The method of claim 7 wherein said copy protection indication is a text file.

11. The method of claim 10 wherein said copy protection indication is an empty file.
